(19) United States
(12) Patent Application Publication
(10) Pub. No.: US 2009/0200951 A1
(43) Pub. Date: Aug. 13, 2009

(54) Methods and Apparatus for Dimming Light Sources

(75) Inventor: Ray J. King, Carolina Beach, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: PureSpectrum, Inc., Savannah, GA (US)

(21) Appl. No.: 12/205,564

(22) Filed: Sep. 5, 2008

Related U.S. Application Data
(60) Provisional application No. 61/006,967, filed on Feb. 8, 2008.

(51) Int. Cl. H05B 37/02

(52) U.S. Cl. 315/206

(57) ABSTRACT

Methods and apparatus for dimming light sources are described herein. In the described examples, a bias circuit selectively biases a switch during a half-cycle of a line current after a delay. In some examples, the delay of the bias circuit is adjustable by a user to adjust the amount of light a light source emits. A charge circuit substantially biases the switch for a period of time in the event the bias circuit experiences an operating condition that may cause the switch to become open during the half-cycle of the line current. As a result of the charge circuit, the light source coupled to the line current does not experience substantial flickering.

### CROSS REFERENCE TO RELATED APPLICATIONS

This application claims the benefit under 35 U.S.C. § 119(e) to U.S. Provisional Patent Application entitled “Two-Wire Dimmer Switch for Dimmable Fluorescent Lights” filed on Feb. 8, 2008, bearing Ser. No. 61/006,967, which is herein incorporated by reference for all that it teaches.

### FIELD OF THE INVENTION

The present invention disclosed and claimed herein relates generally to electronic lighting ballasts and, more particularly, to methods and apparatus for dimming light sources.

### BACKGROUND OF THE INVENTION

In the field of electronic lighting ballasts, some light sources (e.g., gas discharge lamps, fluorescent lamps, etc.) generally present a negative resistance, which causes a power source to increase the amount of current provided to the light source. As a result, a ballast circuit is typically provided to limit the amount of current that the power source provides to the light source. However, conventional dimmer circuits generally work best with light sources that present a positive impedance. As a result, dimmers are typically not implemented on light sources that require ballast circuits that limit the amount of current.

### SUMMARY OF THE INVENTION

Methods and apparatus for dimming light sources are disclosed. A described dimmer circuit includes a switch to selectively couple a first node to a second node. In particular, the first node receives a line current which flows into the second node when the switch is biased ON. A biasing circuit is operable to actuate the switch after a delay during each half-cycle of the line current. Further, the delay of the biasing circuit is based on a setting provided by a user. A charge circuit provides energy to the switch for a period of time to substantially actuate it for the duration of the half-cycle of the line current. In particular, the charge circuit is operable to provide energy to the switch such that the switch remains biased in the event of a first operating condition that, in some examples, may bias the switch closed.

The charge circuit generally comprises a circuit that generates a voltage from the line current. The voltage generated is stored in the charge circuit by an energy storage device such as a capacitor, for example. However, if the voltage stored in the charge circuit exceeds a certain threshold, a further circuit is operable to remove excess voltage from the energy storage device. Further, the charge circuit comprises a second switch that is implemented by a transistor, for example, to provide a voltage to the bias circuit in response to actuating the switch.

### BRIEF DESCRIPTION OF THE DRAWINGS

FIG. 1 is a block diagram of a dimmer circuit connected to a ballast.

FIG. 2 is a block diagram of an example dimmable light system in accordance with aspects of the present invention.

FIG. 3 is a flow diagram of a process that the example dimmer circuit of FIG. 2 may implement.

FIG. 4 is a schematic diagram of an example circuit that may implement the example process of FIG. 3.

FIG. 5 is another schematic diagram of an example circuit that may implement the example process of FIG. 3.

### DETAILED DESCRIPTION OF EXEMPLARY EMBODIMENTS

Methods and apparatus for dimming light sources are described herein. In the described examples, a dimmer circuit is described that allows an operator to control the intensity of the light emitted by a light source with little or no flickering by the light. In addition, the dimmer circuit can be implemented with ballasts for gas discharge lamps (e.g., fluorescent lamps, etc.) as well as traditional light sources (e.g., an incandescent lamp, etc.).

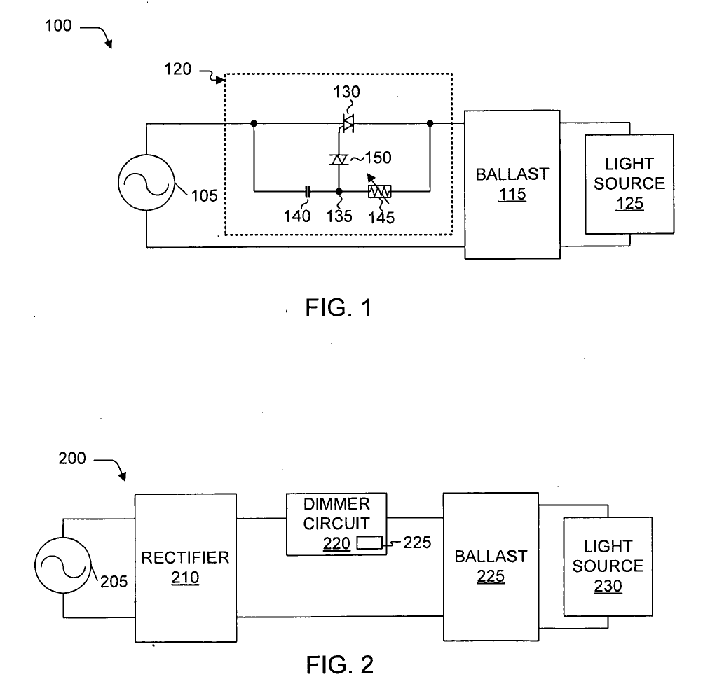

FIG. 1 illustrates a block diagram of a lighting system 100 implementing a ballast with a conventional dimmer circuit. As will be described in detail below, the lighting system 100 is generally not implemented with conventional gas discharge lamps due to substantial flickering. In FIG. 1, a power source 105 (e.g., an alternating line current, etc.), which typically has a current that alternates at a line frequency (e.g., 60 Hertz (Hz), etc.), is coupled to a ballast 115 via a dimmer circuit 120, which limits the current flowing into ballast 115. Dimmer circuit 120 is adjustable and allows an operator to limit the amount of current flowing from dimmer circuit 120 and into ballast 115, which is intended to allow the operator to control the intensity of the light emitted from a light source 125 (e.g., a gas discharge lamp, an incandescent bulb, a light emitting diode (LED), etc.) coupled to ballast 115. Ballast 115 also limits the current to ensure that too much current does not enter light source 125.

In FIG. 1, dimmer circuit 120 is typically implemented by a triac 130 to limit the current flowing from its first terminal, which is typically referred to as MT1, to its second terminal, which is typically referred to as MT2. Triac 130 generally blocks current from flowing until a current is applied to its gate, which causes it to become latched-up and form a low impedance path from its first terminal to its second terminal. In particular, the triac 130 allows current to flow in both directions. When latched-up, the gate of the triac 130 cannot control its operation and a specific condition must typically occur for the triac 130 to become unlatched, which is generally when no current is flowing across its terminals. In FIG. 1, the first terminal of triac 130 is coupled to a node 135 via a capacitor 140 and the second terminal of triac 130 is coupled to node 135 via an adjustable resistor 145 (e.g., a potentiometer, etc.). Node 135 is coupled to the gate of triac 130 via a diac 150.

In the operation of the dimmer circuit 115, capacitor 140 and the adjustable resistor 145 form a network that has a time constant, which generally delays the voltage provided via power source 105. If the voltage at node 135 does not exceed a threshold associated with diac 150 (e.g., ±30 volts, etc.), diac 150 will not apply a current to triac 130, thus preventing current from flowing into ballast 115. On the other hand, once the voltage at node 135 exceeds the threshold, diac 150 turns ON and applies a current to the gate of triac 130, thereby allowing current to flow from power source 105 to ballast 115. In this configuration, triac 130 is latched ON and does not turn OFF until a predetermined condition occurs, which is typically when there is no current flowing across triac 130. Thus, the resistance value of adjustable resistor 145 delays the point at which the light source 125 turns ON during each half-cycle of the line current, which is perceived as intensity to a human eye.

However, in a typical building, many light sources are typically required. As a result, a substantial amount of wire is required to electrically couple the light sources to the respective power source. Generally, wiring has a small amount of parasitic inductance, but the sum of the inductances due to the quantity of light sources required in a building causes a substantial amount of parasitic inductance to be present on each wire that is coupled to the ballast circuits. Further, conventional ballast 115 includes a large electrolytic capacitor (not shown) to store energy therein. During the operation of the ballast 115, the capacitor therein is charged at the beginning of every half-cycle of line current until its voltage is substantially equal to the voltage provided via the power source 105. However, the inductance associated with the wiring also stores energy, thereby causing the voltage of ballast 115 to exceed the voltage provided via power source 105. As a result, during the operation of the lighting system 100, the voltage of triac 130 reverses polarity (i.e., becomes negative) and no current flows across the triac 130. Because the triac 130 experiences no current flowing across its terminals, it unlatches and temporarily turns dimmer circuit 120 OFF.

In other words, dimmer circuit 120 experiences a ringing voltage when used in conjunction with ballast 115 and causes light source 125 to have a flicker that is perceivable to the human eye. Generally, the ringing voltage occurs several times within the first 250 microseconds of actuating triac 130. As a result of the flicker, dimmer circuits are conventionally not implemented with ballast circuits using conventional light sources. Rather, special light sources (e.g., modified florescent lamps) are required in order to use a conventional dimmer with a ballast. However such modified florescent lamps typically have a power rating of greater than 40 watts and are generally able to dim the light somewhere in the range of approximately 20% to 95%.

FIG. 2 illustrates a block diagram of an example light system 200 in accordance with the present invention that implements a dimmer circuit that has substantially no flickering. In the illustrated example of FIG. 2, a power source 205 (e.g., an alternating line current, etc.), which typically has a current that alternates at a line frequency (e.g., 60 Hz, etc.), is coupled to a rectifier 210. Rectifier 210, which is coupled to a ballast 215 via a dimmer circuit 220, rectifies the line current of power source 205, thereby doubling the line frequency (e.g., to 120 Hz, etc.) conveyed to ballast 215. Dimmer circuit 220 adjustably limits the amount of current provided to ballast 215, which is configured by a user, for example. To prevent substantial amount of flickering, dimmer circuit 220 includes a charge circuit 225 to store energy therein (e.g., a voltage, etc.). Of course, ballast 215 also passes current into a light source 230 to emit light therefrom.

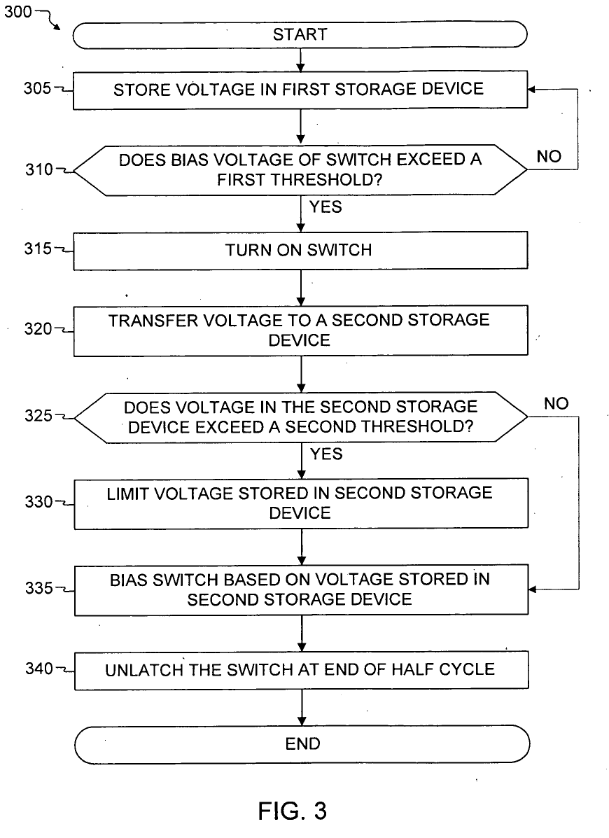

FIG. 3 illustrates an example process 300 in accordance with the present invention that dimmer circuit 220 (FIG. 2) may implement. In particular, the operation of exemplary process 300 typically occurs during a half-cycle of the line current (e.g., 120 Hz, etc.), which continually repeats to provide light to a user. Exemplary process 300 begins by storing a voltage in a first storage device (block 305). For example, a voltage may be stored in a capacitor coupled to a power source. Exemplary process 300 determines if a bias voltage of a switch exceeds a first predetermined threshold voltage (block 310). If the bias voltage does not exceed the first predetermined threshold, exemplary process 300 returns to block 305 to store additional voltage.

Alternatively, if the bias voltage exceeds the first threshold, exemplary process 300 turns ON (i.e., latches) the switch (block 315). In some examples, the switch actuates a light source based on a time delay from the start of the half-cycle of the line frequency. In response to turning ON the switch, exemplary process 300 generates a second voltage from the first voltage, and the second voltage that is stored in a second storage device (block 320). After storing the voltage in the second storage device, exemplary process 300 determines if the voltage in the second storage device exceeds a second predetermined threshold (block 325). If the voltage stored in the second storage device exceeds the second threshold, exemplary process 300 limits (.e.g., reduces) the voltage stored in the second storage device (block 330). If the voltage stored in the second storage device does not exceed the second threshold or after reducing the voltage, exemplary process 300 biases the switch based on the voltage stored in the second storage device (block 335). In some examples, exemplary process 300 biases the switch ON for a period of time in the range of approximately 100 to 1000 microseconds. In particular, exemplary process 300 biases the switch so that it unlatches (i.e., closes) at the end of each half-cycle of line current. Accordingly, at the end of the half-cycle of the line current, exemplary process 300 unlatches the switch (block 340) and ends.

In exemplary process 300, the operation of the charge circuit substantially prevents the bias voltage of the switch from falling below a threshold voltage to keep the switch, such as a triac latched ON. Thus, in the event of an operating condition such as a ringing voltage in which a triac would experience substantially no current flowing from across its terminals, the gate of the triac remains biased to keep the triac substantially latched ON. Further, the charge circuit is operable to allow the switch to shut OFF at the end of each half-cycle of the line current. Accordingly, a light source connected to such a dimmer that implements exemplary process 300 would experience substantially no flickering during its operation.

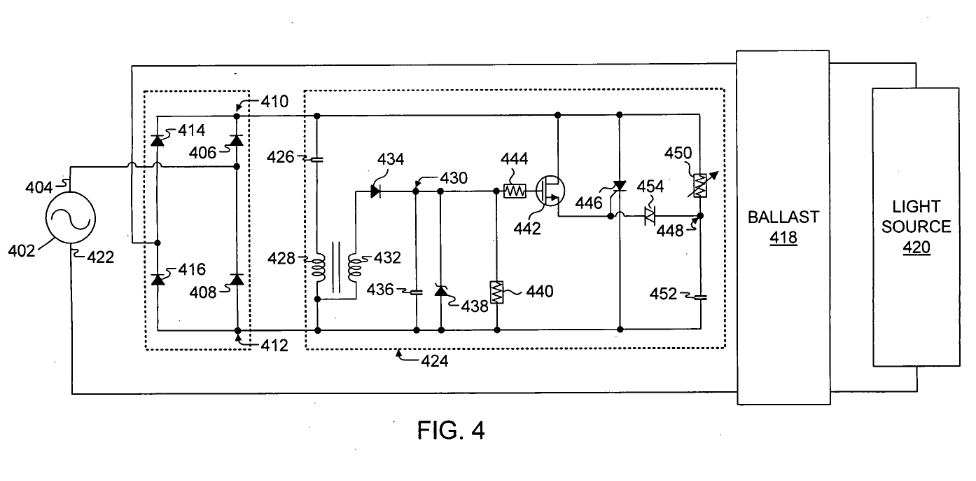

FIG. 4 is a schematic diagram of an example light system 400 that may include a dimmer that implements exemplary process 300. In the illustrated example of FIG. 4, a power source 402 is coupled to a rectifier via its first terminal 404. In particular, the power source 404 is coupled to the anode of a diode 406 and the cathode of a diode 408. The cathode of diode 406 is coupled to a first node 410 and the anode of diode 408 is coupled to a second node 412. The cathode of a diode 414 is coupled to node 410 and the anode of a diode 416 is coupled to node 412. The anode of diode 414 and the cathode of diode 416 are both coupled to a ballast 418, which is further coupled to a light source 420 (e.g., a gas discharge lamp, a fluorescent lamp, a LED, an incandescent bulb, etc.). Ballast 418 is also coupled to a second terminal 422 of power source 402. In the illustrated example, diodes 406, 408, 414, and 416 form a rectifier, such as rectifier 210 of FIG. 2.

In the illustrated example of FIG. 4, nodes 410 and 412 are further coupled to a dimmer circuit 424, such as dimmer circuit 220 having charge circuit 225 in the example of FIG. 2. In particular, node 410 is coupled to node 412 via a capacitor 426 and a primary winding 428. Node 412 is further coupled to a third node 430 via a secondary winding 432 and a diode 434. In the illustrated example, the cathode of diode 434 is coupled node 430. Further, node 430 is coupled to node 412 via a capacitor 436, a zener diode 438, and a resistor 440, each of which are configured in parallel. Node 430 is coupled to the gate of a transistor 442 via a resistor 444.

In the illustrated example, transistor 442 is implemented by an N-channel metal oxide semiconductor field effect transistor (MOSFET), but transistor 442 can be implemented by any suitable device (e.g., a switch, a bipolar transistor, a P-Channel MOSFET, an insulated gate bipolar transistor, etc.). The drain of transistor 442 is coupled to node 410 and its respective source is coupled to the gate of a silicon controlled rectifier (SCR) 446 (e.g., a Shockley diode, etc.). In the example of FIG. 4, node 410 is also coupled to node 412 via SCR 446. Further, node 410 is coupled to a fourth node 448 via an adjustable resistor 450 (e.g., a potentiometer, etc.). Node 448 is coupled to node 412 via a capacitor 452 and node 448 is further coupled to the gate of SCR 446 via a diac 454.

The operation of the dimmer circuit 424 will be explained in conjunction with a half-cycle of the line frequency of the power source 402. In particular, the diodes 406, 408, 414, and 416 cause a line current to flow into the dimmer circuit 424 via node 410. Initially, substantially no current flows at the beginning of the half-cycle of the line current. However, the line current begins to flow but does not flow from node 410 to node 412 because SCR 446 is initially off and the resistor 450 and capacitor 452 also prevent the line current from flowing. Further, capacitor 426 stores an amount of current as a voltage. The resistor 450 and capacitor 452 increase the voltage at node 448 at a rate that is determined by the resistance value of the resistor 450, which is typically selected by a user. After a delay based on the value of resistor 450, the voltage at node 448 exceeds a threshold voltage associated with diac 454. As a result, diac 454 enters what is commonly referred to as “breakdown” mode and allows current to flow across its respective terminals. In response, a current flows into the gate of SCR 446, which causes SCR 446 to latch ON and couple node 410 to 412 via a low impedance path. SCR 446 is latched ON, thereby causing its respective gate to lose control over its operation. SCR 446 remains latched ON until it experiences an operation condition to unlatch, which is typically when current is not flowing across its respective gates.

When current begins to flow across SCR 446, capacitor 426 discharges the voltage stored therein as a current across the primary winding 428, which induces a current in the secondary winding 432. In particular, primary and secondary windings 428 and 432 cause node 430 to have a voltage, but the voltage at node 430 is configured to not exceed the voltage at node 410. As will be described in detail below, because node 410 is coupled to power source 402, the voltage at node 430 is reduced to provide power to prevent SCR 446 from unlatching (i.e., turning OFF).

In the illustrated example, the current from secondary winding 432 is stored in capacitor 436, thereby causing node 430 to have a voltage. Further, diode 434 prevents current from flowing into node 412 when the voltage at node 430 exceeds the voltage at node 412. However, if the voltage at node 430 exceeds a breakdown voltage associated with zener diode 438, zener diode 438 enters what is commonly referred to as the “avalanche breakdown mode” and allows current to flow from its cathode to its anode (i.e., into node 412). Once the voltage at node 430 does not exceed the breakdown voltage, the zener diode 438 recovers and prevents current from flowing into node 412. Stated differently, the zener diode 438 limits the voltage stored in the capacitor 436 so that its voltage does not exceed a predetermined threshold.

Resistors 440 and 444 cause capacitor 436 to release the voltage stored therein as a current. In particular, Resistors 440 and 444 are configured to cause transistor 442 to have a gate-source voltage, thereby turning it ON and causing the gate of SCR 446 to have a voltage based on the voltage stored in capacitor 436. Stated differently, resistors 440 and 444 keep the gate of SCR 446 energized for a period of time based on the amount of voltage stored in capacitor 436. In the illustrated example, zener diode 438, capacitor 436, and resistors 440 and 444 are configured to bias the gate of SCR 446 for a period of time approximately in the range of 100 to 1000 microseconds. Stated differently, the example dimmer circuit 424 biases SCR 446 for a portion of each half-cycle of the line current and unlatches SCR 446 at the end of each half-cycle.

As described above, if driving a capacitive load such as an electronic ballast, a parasitic impedance in the wiring of a building may cause SCR 446 to experience a ringing voltage, which may cause no current to flow across SCR 446. In other words, SCR 446 may experience the operating condition that may cause it to unlatch. At the same time, no current will flow across adjustable resistor 450 and the capacitor 452, which causes diac 454 to unlatch. However, as described above, capacitor 436 stores a voltage in response to turning ON SCR 446, which causes the transistor 442 to have a gate-source voltage. As a result of the gate-source voltage of transistor 442, SCR 446 has a gate voltage and remains latched ON for substantially the same the duration that transistor 442 is turned ON. That is, when SCR 446 is turned ON, it receives a voltage to prevent it from becoming unlatched as a result of the ringing voltage. As a result, the light source 420 does not flicker during the operation of each half-cycle of the line current.

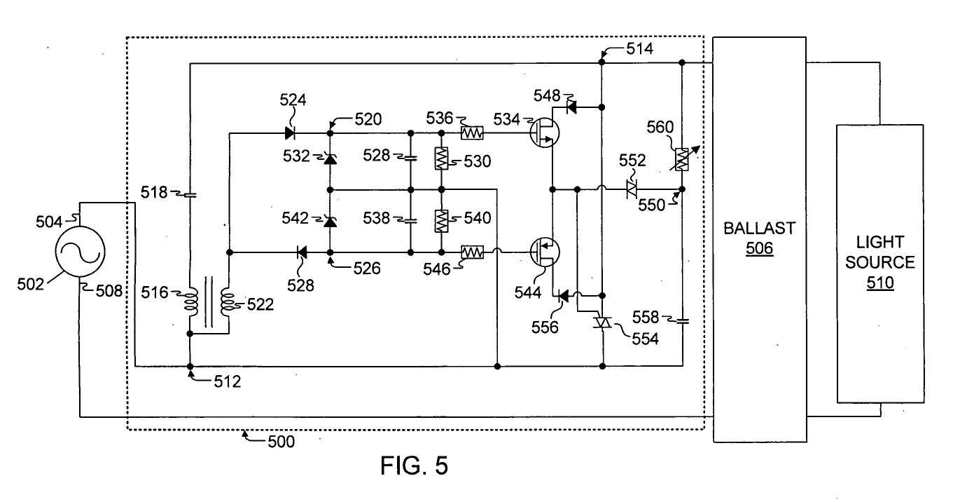

FIG. 5 illustrates another example circuit 500 that may implement exemplary process 300. In the example of FIG. 5, a power source 502 is coupled to exemplary circuit 500 via its respective first terminal 504. In particular, the power source 502 is coupled to a ballast 506 via exemplary circuit 500. Further, exemplary circuit 500 is also coupled to a second terminal 508 of power source 502. Ballast 506 is coupled to a light source 510 to emit light therefrom.

The first terminal 504 of power source 502 is coupled to a first node 512, which is further coupled to a second node 514 via a primary winding 516 and a capacitor 518. Node 512 is further coupled to a second node 520 via a secondary winding 522 and a diode 524. In particular, the cathode of diode 524 is coupled to node 520 and its respective anode is coupled to secondary winding 522. In addition, node 512 is coupled to node 526 via secondary winding 522 and a diode 528, which has its respective anode coupled to node 526 and its cathode coupled to secondary winding 522.

Node 520 is also coupled to node 512 via capacitor 528 and resistor 530, which are configured in parallel. Further, node 520 is also coupled to the cathode of a zener diode 532, which is coupled to node 512 via its respective anode. Further still, node 520 is also coupled to the gate of a transistor 534 via a resistor 536. In the example of FIG. 5, node 526 is coupled to node 512 via a capacitor 538 and a resistor 540, which are configured in parallel. In addition, node 526 is coupled to the anode of a zener diode 542, which is coupled to node 512 via its respective cathode. Node 526 is also coupled to the gate of a transistor 544 via a resistor 546. In the illustrated example of FIG. 5, transistor 534 is implemented by an N-Channel MOSFET and transistor 546 is implemented by a P-Channel MOSFET. Of course, transistors 536 and 546 can be implemented by any suitable device (e.g., bipolar transistors, etc.).

The drain of transistor 534 is coupled to node 514 via a diode 548. In particular, the anode of diode 548 is coupled to node 514 and its respective cathode is coupled to the drain of transistor 534. The source of transistor 534 is coupled to the source of transistor 544, both of which have their respective sources that are further coupled to a node 550 via a diac 552. In addition, the sources of transistors 534 and 544 are coupled to the gate of a triac 554. The drain of transistor 544 is coupled to node 514 via a diode 556. In particular, the anode of diode 556 is coupled to node 514 and its respective cathode is coupled to the drain of transistor 544.

In the illustrated example of FIG. 5, node 512 is coupled to node 514 via the main terminals of triac 554. Node 512 is also coupled to node 550 via a capacitor 558 and node 550 is further coupled to node 514 via an adjustable resistor 560 (e.g., a potentiometer, etc.). In particular, resistor 560 is adjustable by a user and is operable to selectively allow current to flow through exemplary circuit 500 to cause light source 510 to emit light therefrom. In the illustrated example, node 514 is further coupled to ballast 506.

In the illustrated example of FIG. 5, exemplary circuit 500 operates in a manner similar to the description of FIG. 4. In particular, the adjustable resistor 560 and capacitor 558 form a circuit having a time constant and is adjustable based on the resistance of the resistor 560. Initially, the capacitor 518 stores an amount of voltage when the SCR 554 is turned OFF. When the voltage node 550 exceeds a threshold voltage associated with the diac 552 (e.g., ±30 volts, etc.), current flows into the gate of triac 554 to latch it ON, thereby forming a low impedance path from node 512 to node 514. In response, the capacitor 518 releases the voltage as a current, which induces a current in the secondary winding 522.

If the current generated by the secondary winding 522 is negative, a current flows into node 526 and capacitor 538 stores the current as a voltage. However, zener diode 542 limits the voltage stored in capacitor 538. As a result of the voltage, the resistors 540 and 546 cause a current to flow into node 512. Of course, the resistors 540 and 546 are configured to limit the amount of current. As a result, a voltage is generated and causes transistor 544 to have a gate-source voltage, thereby turning ON transistor 544. However, because the resistors 540 and 546 limit the current, transistor 544 is turned ON for a period of time after triac 554 latches ON. In some examples, the transistor 544 is operable for a range of approximately 100 to 1000 microseconds. As a result of turning ON transistor 544, triac 554 continues to have a gate voltage, thereby ensuring the triac 554 is latched for a period of time after turning ON.

On the other hand, if the current generated from secondary winding 522 is positive, a current flows into node 520 via diode 524. The current is stored in the capacitor 528 as a voltage, however, zener diode 532 limits the voltage stored therein. As a result of the voltage, the resistors 530 and 536 cause a current to flow into node 512. Of course, the resistors 530 and 536 are configured to limit the amount of current. In response to the current, a voltage is generated and causes transistor 534 to have a gate-source voltage, thereby turning it ON. However, because resistors 530 and 536 limit the current, transistor 534 is turned ON for a period of time once triac 554 is latched ON (e.g., 100 microseconds, 1000 microseconds, etc.). As a result of turning on transistor 534, triac 554 continues to have a gate voltage, thereby ensuring the triac 554 is latched for a period of time after turning ON.

In the example of FIG. 5, exemplary circuit 500 is operable to allow current to flow in both directions across triac 554, which remains latched during both the positive half-cycle of the line current and the negative half-cycle of the line current. As a result, exemplary circuit 500 does not require a rectifier, for example. On the other hand, in the example of FIG. 4, the dimmer circuit 424 requires fewer components by implementing a rectifier and allowing current to flow in one direction across the SCR 446.

In the described examples, a dimmer circuit is provided that is able to dim light sources without noticeable flicker. Further, the dimmer circuit is capable of operating with any type of light source (e.g., incandescent bulbs, gas discharge lamps, LEDs, etc.) over the full range of light output (e.g., from 0% to 100%). The dimmer circuit can easily be implemented into existing manufacturing processes without substantial costs. In addition, the dimmer circuit is capable to handling lower current, approximately in the range of 10 to 20 milliamps, thereby allowing the ballast to be implemented with conventional light sources (e.g., LEDs, florescent lamps, etc.). As a result, the described examples above are capable of handling low power light sources such as a five watt florescent lamp, for example.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A method of dimming a light source, comprising:
storing a voltage in an energy storage circuit;
during each half-cycle of a line current, coupling a first node to a second node via a switch after a delay;
emitting light from a light source based on the line current; and
in response to coupling the first node to the second node, providing the voltage from the energy storage circuit to the switch for biasing the switch for a first period of time.

2. A method as defined in claim 1, wherein the intensity of light emitted from a light source is based on the delay.

3. A method as defined in claim 2, wherein the delay is based on a setting provided via a user.

4. A method as defined in claim 3, wherein providing the energy to the switch substantially prevents a first condition from unlatching the switch.

5. A method as defined in claim 1, further comprising generating the voltage via the line current, wherein the voltage is stored in the energy storage circuit.

6. A method as defined in claim 1, wherein providing the voltage from the energy storage circuit comprises generating a second voltage in a second storage circuit.

7. A method as defined in claim 6, wherein providing the voltage from the energy storage circuit further comprises reducing the second voltage if the second voltage exceeds a predetermined threshold.

8. A method as defined in claim 7, wherein providing the voltage from the energy storage circuit further comprises generating a current for a predetermined period of time.

9. A method as defined in claim 1, further comprising unlatching the switch at the end of each half-cycle of line current.

10. A dimmer circuit for controlling the light intensity emitted from a light, comprising:
a switch to selectively couple a first node to a second node, wherein the first node receives a line current;
a biasing circuit to actuate the switch after a delay during each half-cycle of the line current, the delay being based on a setting from a user; and
a charge circuit to provide energy to the switch for a period of time to substantially actuate the switch for the duration of the half-cycle of the line current.

11. A dimmer circuit as defined in claim 10, wherein the charge circuit comprises a primary and secondary winding operable to generate a voltage in response to actuating the switch.

12. A dimmer circuit as defined in claim 11, wherein the charge circuit further comprises a first energy storage device operable to store a voltage and a second energy storage device operable to store the generated voltage.

13. A dimmer circuit as defined in claim 11, wherein the charge circuit further comprises a limiting device operable to limit the voltage stored in the second energy storage device to a threshold voltage if the generated voltage exceeds the threshold voltage.

14. A dimmer circuit as defined in claim 11, wherein the charge circuit further comprises a transistor having a first terminal coupled to the second energy storage device and a second terminal coupled to the switch.

15. A dimmer circuit as defined in claim 14, wherein the transistor provides a voltage to the switch for a predetermined period of time after actuating the switch.

16. A dimmer circuit as defined in claim 10, wherein the switch comprises a silicon controlled rectifier (SCR).

17. A dimmer circuit as defined in claim 16, wherein, in response to actuating the SRC, the charge circuit provides energy to a gate of the SRC.

18. A dimmer circuit as defined in claim 16, wherein, in response to a first condition during the half-cycle of the line current, the SCR is substantially latched.

19. A dimmer circuit as defined in claim 16, wherein the SCR turns off at the end of the half-cycle of the line current.

20. A dimmer circuit as defined in claim 10, wherein the biasing circuit comprises a first circuit having a time constant and a diac, wherein the diac actuates the switch when a voltage of the first circuit exceeds a predetermined threshold.

21. A dimmer circuit for controlling the light intensity emitted from a light, comprising:
a silicon controlled rectifier (SCR) having a first terminal coupled to a first node and a second terminal coupled to a second node;
an adjustable resistor having a first terminal coupled to the first node and a second node coupled to a third node;
a diac having a first terminal coupled to the third node and a second terminal coupled to a gate of the SCR;
a first capacitor having a first terminal coupled to the third node and a second terminal coupled to the second node;
a primary winding having a first terminal coupled to the first node via a first capacitor and a second terminal couple to the second node;
a diode having a first terminal coupled to a fourth node and a second terminal coupled to the second node via a secondary winding;
a second capacitor having a first terminal coupled to the forth node and a second terminal coupled to the second node;
a zener diode having a first terminal coupled to the forth node and a second terminal coupled to the second node;
a first resistor having a first terminal coupled to the forth node and a second terminal coupled to the second node; and
a transistor having a drain coupled to the first node, a source coupled to the gate of the SCR and a gate coupled to the fourth node via a second resistor.

22. A dimmer circuit for controlling the light intensity emitted from a light, comprising:
a triac having a first terminal coupled to a first node and a second terminal coupled to a second node;
an adjustable resistor having a first terminal coupled to the first node and a second node coupled to a third node;
a diac having a first terminal coupled to the third node and a second terminal coupled to a gate of the SCR;
a first capacitor having a first terminal coupled to the third node and a second terminal coupled to the second node;
a primary winding having a first terminal coupled to the first node;
a second capacitor having a first terminal coupled to the second terminal of the primary winding and a second terminal coupled to the second node;
a secondary winding having a first terminal coupled to the first node;
a first diode having an anode coupled to the second terminal and a cathode coupled to a fourth node;
a third capacitor having a first terminal coupled to the fourth node and a second terminal coupled to the first node;
a first zener diode having a cathode coupled to the fourth node and an anode coupled to the first node;
a first transistor having a first terminal coupled to the fourth node via a second resistor, a second terminal coupled to the second node via a second diode, and a third terminal coupled to the gate of the triac;
a third diode having a cathode coupled to the second terminal of the secondary winding and an anode coupled to a fifth node;
a fourth capacitor having a first terminal coupled to the firth node and a second terminal coupled to the first node;
a second zener diode having an anode coupled to the fifth node and a cathode coupled to the first node; and
a second transistor having a first terminal coupled to the fifth node via a third resistor, a second terminal coupled to the second node via a fourth node, and a third terminal coupled to the gate of the triac.
